(19) United States
(12) Patent Application Publication
(10) Pub. No.: US 2017/0024269 A1
(43) Pub. Date: Jan. 26, 2017

(54) ASSOCIATING ERROR EVENTS WITH INPUTS TO APPLICATIONS

(71) Applicant: Hewlett-Packard Development Company, L.P., Houston, TX (US)

(72) Inventors: Haim Shuvali, Yehud (IL); Guy Offer, Yehud (IL)

(21) Appl. No.: 14/804,654

(22) Filed: Jul. 21, 2015

(51) Int. Cl. G06F 11/07

(52) U.S. Cl. CPC G06F 11/0772; G06F 11/0706; G06F 11/079

(57) ABSTRACT

Associating error events with inputs to applications can refer to associating each of a plurality of different error event types encountered in response to an input to an element of an application displayed in a graphical user interface (GUI) of a user device with a unique identifier of the input and representing an error event type of the different error event types associated with the unique input identifier in a GUI of a support device

### BACKGROUND

Business processes may be a factor in the operational success of an organization. The business processes may be implemented using applications and/or user interfaces. As such, the organization may have an interest in ensuring that the applications and/or the user interfaces operate properly (e.g., as intended). Therefore, the organization may evaluate issues associated with an application such as a mobile application and/or a user interface related to the application.

### BRIEF DESCRIPTION OF THE DRAWINGS

FIG. 1 illustrates an example of an environment in which various examples can be implemented to associate error events with inputs to applications according to the disclosure.

FIG. 2 illustrates a diagram of an example of a graphical user interface (GUI) according to the disclosure.

FIG. 3 illustrates a diagram of another example of a GUI according to the disclosure.

FIG. 4 illustrates a diagram of an example of a system to associate error events with inputs to applications according to the disclosure.

FIG. 5 illustrates a diagram of an example of a computing device to associate error events with inputs to applications according to the disclosure.

FIG. 6 illustrates a flow diagram of an example of a method to associate error events with inputs to applications according to the present disclosure.

### DETAILED DESCRIPTION

Applications such as mobile applications can utilize user interfaces such as graphical user interfaces (GUI) to provide information to users and/or receive information from users. For example, GUIs can enable a user to provide a variety of inputs associated with the application and/or view a display of information associated with the application, as described herein. Organizations may seek to increase efficiencies related to applications supporting their business processes, for instance, by pursuing efficient resolution of error events.

An error event is an application event experienced from a perspective of a user device and thus from a perspective of a user. Error events can include responses to user actions and/or application faults. Application faults can include fatal application crashes and non-fatal errors. Responses include application launches and other user interface updates performed in response to user interaction with the application's user interface. Examples of error events include Hypertext Transfer Protocol (HTTP) error events or other networking type of error events, crash error events, and/or handled exception error events (e.g., occurrence of a handled exception or other error event specified in a software development kit associated with an application), among other types of error events. That is, an error event may occur in response to an input provided by a user (e.g., an end user) of an application at a user device.

Some example approaches to reporting error events may report different types of error events separately. For example, all HTTP error events may be reported together without inclusion of other types of error events (e.g., HTTP error events). However, such approaches may not account for relationships and/or interaction between different types of error events. In addition such approaches may not associate an error event type, let alone a plurality of error event types, with an input such of those provided by a user of an application that triggered the error event(s). As such, a business context and/or a business impact of errors may not be appreciated and/or available when using some approaches to reporting error event. Moreover, such approaches may not represent an error event notification message as originally displayed by a user device in a support device.

Accordingly, examples of the present disclosure include methods, systems, and computer-readable and executable instructions to associate error event with inputs to applications. Associating error events with inputs to applications can for example include associating each of a plurality of different error event types encountered in response to an input to an element of an application displayed in a GUI of a user device with a unique identifier of the input and representing an error event type of the different error event types associated with the unique input identifier in a GUI of a support device.

In some examples, associating multiple error events (e.g., an HTTP error event and a corresponding error event notification displayed to a user of a user device) with a unique identifier of an input to an application may, for example, promote evaluation of application performance, enhanced operation of business processes, and/or an enhanced user experience with the application. Associating error events with inputs to applications may, for example, be performed for sessions of a plurality of users utilizing an application at a plurality of user devices, as described herein.

Applications generally run on at least one thread (e.g., an execution stream) which is initialized during the launch of the application. For example, when an application is launched, a computing device may create a main thread of execution for the application that includes information identifying a user and/or a device launching the application. A main thread may be in charge of the application's user interface. In some instances, when a user interacts with the user interface (e.g., by clicking a button), the main thread may be executing in the background to complete tasks associated with the user action. For example, the application may create and run an object (e.g., an entity that consists of data and functions) on the main thread, which in turn may create a number of separate background threads to divide the work associated with the user action into separate pieces. These pieces may then be run in parallel on various background threads so that the application can run more quickly and efficiently. This way, the main thread may continue to be responsive while any objects created in response to a user action are being processed. In this manner, an object can have an object identifier and a thread can have thread identifier where the object identifier is unique to the object and the thread identifier is unique to the thread. Associating the thread identifiers and/or the object identifiers that experience an error event in response to an input to an element of an application with a unique identifier of an input can promote associating error events with inputs to applications, as described herein.

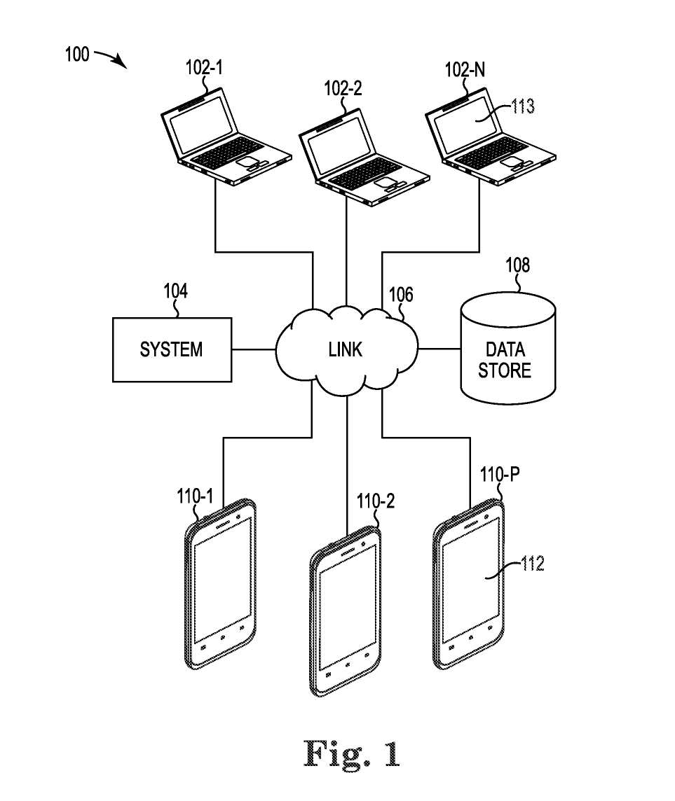

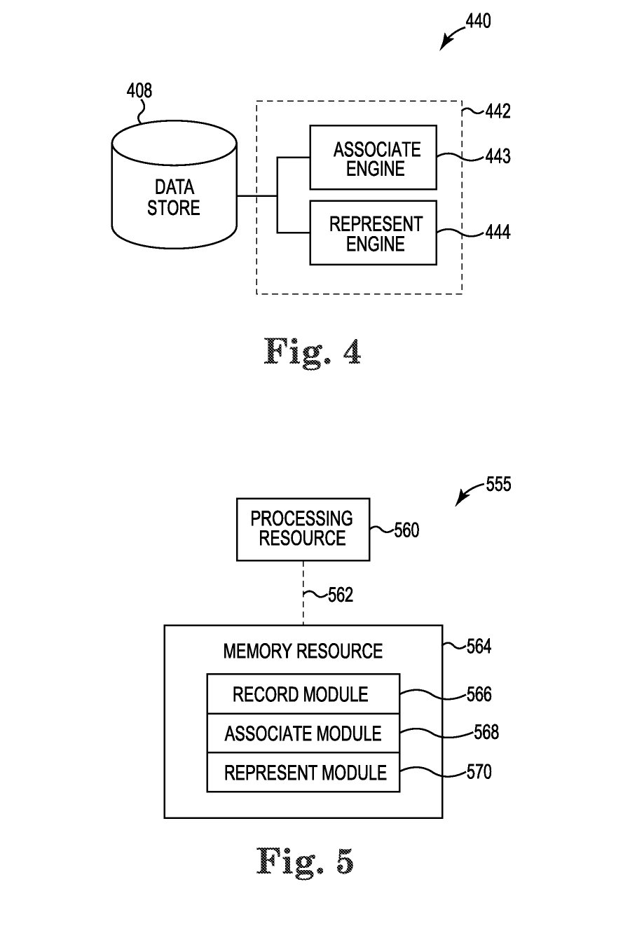

FIG. 1 illustrates an example of an environment 100 in which various examples can be implemented to associate error events with inputs to applications according to the disclosure. The environment 100 is shown to include a system 104 to associate error events with inputs to applications, support devices 102-1, 102-2, . . . , 102-N, user devices 110-1, 110-2, . . . , 110-P, a data store 108, and a link 106. The data store 108 can be analogous to those discussed with respect to FIG. 4. The system 104 can include a computing device analogous to those discussed with respect to FIG. 5.

Associating error events with inputs to applications can be performed using a support device such as the support devices 102-1, . . . , 102-N and/or a user device, such as the user devices 110-1, . . . , 110-P. Each of the user devices 110-1, . . . 110-P refers to an electronic device suitable to execute a function of an application such a mobile application, processing information (e.g., network traffic) related to the application, and/or displaying a GUI utilized by an application. Examples of user devices can include mobile devices, payment instruments, tablets, desktop computers, and/or laptop computers, among other types of user devices. That is, while the user devices 110-1, . . . 110-P are illustrated as mobile phones, the present disclosure is not so limited in that the user devices can be various mobile or non-mobile devices suitable to associate error events with inputs to applications, as described herein.

The user devices 110-1, . . . , 110-P are computing devices that can generate electronic data (e.g., generate a version of a GUI) having browsers and/or other applications to communicate such information associated with a GUI and/or having an ability to associate error events with inputs to applications, among other abilities. The user devices can include an application executing thereon. For instance, the user devices can be mobile user devices (e.g., mobile phones) with a mobile application executing thereon. The application can be downloaded (e.g., wired or wirelessly) to the user device and/or otherwise conveyed thereto. The application can be in communication with a support device to communicate error events along with other information to the support device to promote associating error events with inputs to applications, as described herein.

The user devices 110-1, . . . , 110-P can include an electronic display such as a GUI 112. The GUI 112 of the user device can display an element of an application (e.g., a mobile application), for example, to promote functioning of the application on the user device. That is, the elements displayed can each have a respective functionality associated therewith. For example, selection of an element may cause the GUI 112 to perform an action (e.g., display a drop down menu, display a free text area, and/or cause an application utilizing the GUI to perform a function). The element can be included in a plurality of elements of the application displayed in the GUI 112 to facilitate a user to interact with the GUI (e.g., provide an input to cause the GUI to perform the functionality) and/or the application executing on the user device including the GUI 112. For example, a grouping of pixels in the GUI may represent an element such as an icon, field, among other types of elements that can receive an input (e.g., a user provided input during a session of an application execution on a user device). Examples of inputs include mouse clicks, audio inputs, tactile inputs (e.g., inputs made via a touch screen), for example, dragging objects displayed in the user interface, and/or a number of key events (e.g., a down key event as a result of depressing a key and/or an up key event as a result of release of a key) on a keyboard of a GUI, among other inputs.

The support devices 102-1, . . . , 102-N can include an electronic display such as GUI 113 suitable for display of electronic data such as a representation an element of an application and/or suitable for interaction with a support personal. Examples of support devices can include mobile phones, laptop computers, desktop computer, and/or servers, among other types of support devices. That is, while the support devices 102-1, . . . , 102-N are illustrated as laptop computers, the present disclosure is not so limited.

A GUI such as those included in the user devices and support devices includes hardware components and/or computer-readable instruction components. Hardware components can include input components (e.g., a mouse, a touch screen, and a keyboard) and/or output components such as a display. A GUI can, for example, electronically represent information such as error events (e.g., a type of error event), application information (e.g., a version of an application) and/or user device information (e.g., a make and/or model of a user device experiencing an error event), among other information. Such information can be displayed and represented via an indicator such as a numeric indicator, a textual indicator, and/or a color, among other indicators to represent error events and/or other information to promote associating errors with inputs to applications.

The support devices are located in a support environment and the user devices are located in a live environment. A support environment refers to an environment that can enable support personnel (e.g., an application developer and/or GUI developer) to modify instructions of the application and/or GUI, among other abilities. Such modifications can be based upon associating error events with inputs to applications. For example, an application can be modified to address and/or mitigate an error event such as those experienced frequently and/or those experienced by large number of user devices, as described herein.

A live environment refers to an environment including a user device having a GUI and/or application capable of experiencing an error event. The live environment is separate and distinct from the support environment. Being separate and distinct refers to an environment being physically separate and/or having separate network resources (e.g., network resources to create network traffic) with respect to another network. In this manner, support personal (e.g., located in a support environment) can perform application troubleshooting, evaluate application performance in the live environment based on error events associated with inputs to applications, and/or evaluate user experience with the application in the live environment.

Link 106 (e.g., a network) represents a cable, wireless, fiber optic, or remote connection via a telecommunication link, an infrared link, a radio frequency link, and/or other connectors or systems that provide electronic communication. That is, the link 106 can, for example, include a link to an intranet, the Internet, or a combination of both, among other communication interfaces. The link 106 can also include intermediate proxies, for example, an intermediate proxy server (not shown), routers, switches, load balancers, and the like. However, the present disclosure is not so limited. That is, link 106 can represent a physical connection between the support devices 102-1, . . . , 102-N and the user devices 110-1, . . . , 110-P to communicate instructions of an application and/or instructions of a GUI between the support devices, the user devices, and/or the data store.

The system 104 to associate error events with inputs to applications can include different combinations of hardware and instructions to associate error events with inputs to applications. The system 104 to associate error events with inputs to applications can include a computing device (not shown), for instance, computing device 555 as discussed with respect to FIG. 5.

FIG. 2 illustrates a diagram of an example of a GUI according to the disclosure. The GUI 215 can be included in a support device. As illustrated in FIG. 2, each of a plurality of different error event types encountered in response to an input to an element of an application are represented in the GUI 215. The input can be provided to a GUI 215 of a user device and/or to GUIs of a plurality of user devices. In any case, each of the different error event types is associated with a unique identifier of the input to promote grouping of error event types encountered in response to the input (e.g., the input provided to the same element displayed in a plurality of GUIs) together. For example, respective thread identifiers and/or respective object identifiers that encounter an error event in response to an input can be included in each of the recorded different error event message types such that the respective thread identifiers and/or respective object identifiers can be associated with a unique identifier of the input.

Such grouping of error event types encountered by a plurality of users of user device across a plurality of sessions using an application may convey an overall user experience with the application, among other information to a support device. For example, the representation in the GUI can include and/or be based on information about objects (e.g., an object identifier) and/or threads (e.g., a thread identifier) that were associated with a unique identifier of an input to an element of an application displayed in a GUI. That is, the particular thread identifier and/or the particular object identifier can be displayed in the GUI and/or information identifying a user and/or a device launching the application based on the thread identifier and/or the object identifier can be displayed in the GUI.

For example, as illustrated in FIG. 2, information displayed in the GUI 215 can include a total number of users 217 of user devices that encountered error events in response to an input to an element of an application displayed in a GUI of a user device. For example, as illustrated in FIG. 2, a total of 32 users (e.g., operating 32 user devices) can have encountered error events in response to an input (select the money transfer menu item) to an element of an application displayed in a GUI of a user device. The total number of users 217 that encountered error events is the sum of all users (i.e., end users) of an application across a plurality of sessions on a plurality of devices for a given time period. As an example, the total number of users 217 that encountered error events in response to an input to an element of an application displayed in GUIs of user devices over the course of a week can be displayed, although various other time periods can be specified.

In various examples, the information in the GUI 215 can include an indicator of particular screen 219 of the mobile application that was displayed on the GUI of the user device at a time the each of the different error event message types was encountered by the user device, a particular input 221 provided to an element of an application displayed in a GUI of a user device that caused the user device to experience an error event, a percentage of a total number of inputs to an element displayed in the GUIs of a plurality of user devices over a period of time that resulted in error events, and/or a version 225 of an application executing on a user device that encountered an error event in response to an input to an element of the application, among other information to promote associating error events with inputs to applications, as described herein. As mentioned, each input 221 is associated with a single unique input identifier of the input.

For example, “select the money transfer menu item” can have a respective input identifier such that each time such an input is provided to a GUI and/or a plurality of GUIs than all subsequent error events encountered by the GUI and/or the plurality of GUIs is associated with the respective input identifier of the input “select the money transfer menu item”. In this manner, those error events encountered in response to the input “select the money transfer menu item” ”, but not other error events, are associated with the unique input identifier of the input “select the money transfer item”. That is, the inputs can include a unique identifier along with other information that can identify the particular type of input, a session identifier associated with the input, an identifier of an element that the input acted upon (e.g. an HTML element), a position identifier, and/or a time identifier (e.g., a time when the input occurred). Notably, each action has a unique input identifier that is unique with regard to the particular action being performed, as described herein. Such unique identifiers can facilitate associating error events with inputs to applications. The information illustrated in FIG. 2 can be displayed periodically, upon receipt of an error event, and/or in response to an input to the GUI 215.

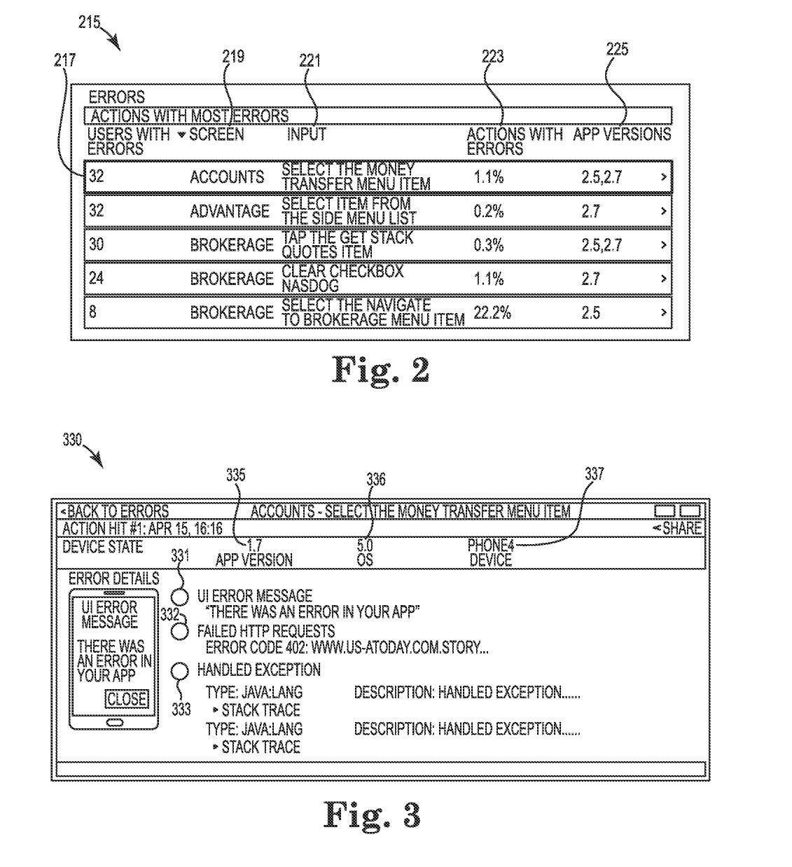

FIG. 3 illustrates a diagram of another example of a GUI 330 according to the disclosure. The GUI 330 may be included in a support device, as described herein. As illustrated in FIG. 3, each of the different error event types encountered in response to an input (e.g., select the money transfer menu item) including an error event notification message (i.e., a GUI error message) 331, a HTTP error event 332, and/or a handled exception error event 333 associated with a respective unique identifier (not shown) can be displayed at the same time in the GUI 330 of a support device, in contrast to other approaches that may display an error event of a particular type (crash) but do not associate such errors with a unique identifier of an input (e.g., an input that resulted in occurrence of the error events), let alone, display at least two error event types (e.g., the an error event notification message 331, the HTTP error event 332, and/or the handled exception error event 333) associated with a unique input identifier at the same time in the GUI of a support device. Such a display may desirably promote efficient error resolution and enhanced user experience, etc.

The GUI 330 may be displayed in response to selection of an item in GUI 215. For instance, in some examples, each of the different error event message types can be represented in response to a selection provided via the GUI of the support device to drill down on a representation of an input (e.g., selection of different error event types associated with the input “select the money transfer menu item”). However, the present disclosure is not so limited. Rather, selection of the items displayed in GUI can provide additional information related thereto and/or promote drilling down to provide a representation of each of a plurality of different error event types included therein, among other possibilities.

FIG. 4 illustrates a diagram of an example of a system to associate error events with inputs to applications according to the disclosure. The system 440 can include a data store 408 (e.g., analogous to data store 108 as referenced in FIG. 1), a system 442 to associate error events with inputs to applications, and/or a number of engines. The system 443 can be in communication with the data store 408. The system 443 to associate error events with inputs to applications can include a number of engines (e.g., a associate engine 434, represent engine 444, etc.). The system 443 to associate error events with inputs to applications can include additional or fewer engines than illustrated to perform the various functions described herein.

The number of engines can include a combination of hardware and instructions to perform a number of functions described herein (e.g., represent an error event type of different error event types associated with the unique input identifier in a GUI of a support device, etc.). Each of the engines can include hardware or a combination of hardware and instructions designated or designed to execute a module (e.g., a particular module). The instructions (e.g., software, firmware, programming, etc.) may be stored in a memory resource (e.g., computer-readable medium) or as a hard-wired program (e.g., logic).

The associate engine 434 can include hardware and/or a combination of hardware and instructions to associate each of a plurality of different error event types encountered in response to an input to an element of an application displayed in a GUI of a user device with a unique identifier of the input. The application is suitable for operation on a user device. For instance, in some examples, the application is a mobile application and the user device is a mobile user device, as described herein.

In some examples, the different error event types can include a first error event type and a second error event type, among other possible error event types. The first error event type can be selected from a HTTP error event, a crash error event, and a handled exception error event. The second error event type can be is an error event notification message such as an error event notification message displayed in the GUI of the user device in response to occurrence of the first error event type. That is, the second error event type can be a user friendly message that indicates an error (e.g., the first error event type) has been experienced by the application executing on the user device.

The represent engine 444 can include hardware and/or a combination of hardware and instructions to represent an error event type of the different error event types associated, for example, by the associate engine 434, with the unique input identifier in a GUI of a support device. For example, the represent engine 444 can in some examples, represent at least two of the different error event types associated with unique input identifier in a GUI of a support device. The at least two of the different error event types can include an HTTP error event, a crash error event, and/or a handled exception error event, among other types of error events.

A representation can include a representation of an error event notification message. For example, the representation can be a reproduction of an error event notification message displayed in the GUI of the support device. That is, the reproduction of the error event notification message can be visually identical to an error event notification message displayed in the GUI of the user device in response to the input. Such a reproduction of an error event notification message as originally displayed by the GUI of the user device that encountered the error event that lead to the error event notification message can promote understanding and/or enhancements of a user experience associated with execution of the application on a user device. Notably, other approaches may not represent an error event notification message as originally displayed by a user device in a support device.

In some examples the system 440 can include a record engine (not shown) to record the plurality of different error event types, for example, those occurring during all sessions of all users using the mobile application on a plurality of mobile user devices. For example, the record engine can record different error event message types displayed in GUIs of a mobile user devices in response to an input to an element of a mobile application represented in the GUIs. However, the present disclosure is not so limited. That is, error events encountered by each of a plurality of mobile user device can be recorded whether or not the error events encountered are themselves displayed in a GUI of a mobile device. Recording different error event message types such as those displayed in GUIs of a mobile user devices can promote subsequent associating and/or representation of the different error event types with a unique identifier of an input, as described herein. Put another way, recording all of the inputs provided by users of the mobile application on a plurality of mobile devices can promote understanding and/or enhancement of a user experience of the mobile application.

FIG. 5 illustrates a diagram of an example of a computing device to associate error events with inputs to applications according to the disclosure. The computing device 555 can utilize hardware and instructions (e.g. software, or firmware), or hardware and logic to perform a number of functions described herein.

For example, the computing device 555 can be a combination of hardware and instructions to associate error events with inputs to applications. The hardware, for example can include a processing resource 560 and/or a memory resource 564 (e.g., computer-readable medium (CRM), database, etc.) A processing resource 560, as used herein, can include a number of processors capable of executing instructions stored by a memory resource 564. Processing resource 560 can be integrated in a single device or distributed across multiple devices. The instructions (e.g., computer-readable instructions (CRI)) can include instructions stored on the memory resource 564 and executable by the processing resource 560 to implement a desired function (e.g., associate each of the different error event message types with the unique input identifier of the input, etc.).

The memory resource 564 can be in communication with a processing resource 560. A memory resource 564, as used herein, can include a number of memory components capable of storing instructions that can be executed by processing resource 560. Such memory resource 564 can be a non-transitory CRM. Memory resource 564 can be integrated in a single device or distributed across multiple devices. Further, memory resource 564 can be fully or partially integrated in the same device as processing resource 560 or it can be separate but accessible to that device and processing resource 560. Thus, it is noted that the computing device 355 can be implemented on a support device and/or a collection of support devices, on a user device and/or a collection of user devices, and/or on a combination of the support devices and the user devices.

The memory resource 564 can be in communication with the processing resource 560 via a communication link (e.g., path) 562. The communication link 562 can be local or remote to a computing device associated with the processing resource 560. Examples of a local communication link 562 can include an electronic bus internal to a computing device where the memory resource 564 is one of volatile, non-volatile, fixed, and/or removable storage medium in communication with the processing resource 560 via the electronic bus.

The memory resource 564 can include a number of modules such as a record module 566, associate module 568, and represent module 570. The number of modules 566, 568, 570 can include CRI that when executed by the processing resource 560 can perform a number of functions. The number of modules 566, 568, 570 can be sub-modules of other modules. For example, the associate module 568 and the represent module 570 can be sub-modules and/or contained within the same computing device. In another example, the number of modules 566, 568, 570 can comprise individual modules at separate and distinct locations (e.g., CRM, etc.).

Each of the number of modules 566, 568, 570 can include instructions that when executed by the processing resource 560 can function as a corresponding engine, including those as described herein. For example, the record module 566 can include instructions that when executed by the processing resource 560 can function as or similar to the record engine (not shown), for example, to record different error event message types displayed in GUIs of a mobile user devices in response to an input to an element of a mobile application displayed in the GUIs. The input is identified by a unique identifier, as described herein. Similarly, the associate module 568 can include instructions that when executed by the processing resource 560 can function as the associate engine 443 to associate each of the different error event message types with the unique input identifier of the input. The represent module 370 can include instructions that when executed by the processing resource 560 can function as the represent engine 444 to represent each of the different error event message types associated with the unique input identifier (e.g., by the associate module 568) in a GUI of a support device.

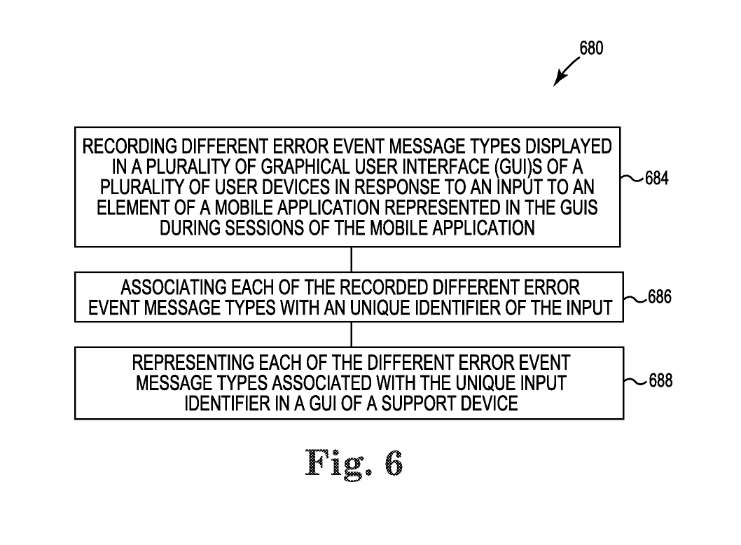

FIG. 6 illustrates a flow diagram of an example of a method 680 to associate error events with inputs to applications according to the disclosure. As shown at 684, in various examples, the method 680 can include recording different error event message types displayed in a plurality of GUIs of a plurality of user devices in response to an input to an element of a mobile application displayed in the GUIs of the mobile user devices during operating sessions of the mobile application. That is, such recording can record different error event types in encountered by at least one user device (e.g., different error event types displayed as a message via a GUI of the user device in response to user provided input to the user device) of a plurality of user devices. Recording can include causing storage of different error event messages and content thereof in a data store such as those described herein and/or providing the different error event messages types and content thereof to a support device.

As shown at 686, the method 680 can include associating each of the recorded different error event message types with an unique identifier of the input, as described herein. In some examples, each of the different types of error events can be associated a single unique input identifier of an input, as described herein. The unique identifier can be particular combination of numerical, alphabetic, and/or alpha-numeric characters, among other types of identifiers. The unique identifier can be a particular combination of numbers such that a unique combination thereof (e.g., X111892) is associated with two or more of the different types of event events (e.g., an error event notification message and a HTTP error event message). Use of such an unique identifier can readily promote associating each of the different error events occurring in response to a particular input (e.g., selection of an selectable icon) to an element (e.g., the selectable icon) represented in a GUI of a user device with the input to the user device and/or representing the different error event message types associated with the unique input identifier in a GUI of a support device, as described herein.

For example, the method 680 can include representing each of the different error event message types associated with the unique input identifier in a GUI of a support device, as shown at 488. Such a representation and the association describe herein can be accomplished without a GUI input (e.g., mouse clicks, audio inputs, tactile inputs, etc.) from a user for instance periodically and/or in response to a user input (e.g., a request for an error event report), among other possibilities.

Representing can include executing instructions stored in memory to directly cause a support device to display, for example, an electronic representation indicative of each of the different error event message types associated with the unique input identifier and/or to communicate data with an expectation that it be processed by another device to cause the support device or other device display an electronic representation indicative of each of the different error event message types associated with the unique input identifier. Similarly, blocks 684 and 686 can include executing instructions stored in memory to perform the examples of the method described therein.

In some examples, each of the different error events can include information about a particular application (e.g., a particular version of an application) and/or a particular type of user device make and/or model that encounter the different error events. For example, a representation of an error event may indicate a particular version (e.g., version 2.0) that was executing on a user device when the error event was encountered. Put another way, a version of an application (e.g., a mobile web application) can be displayed in the GUI of the support device along with the representations of each of the different error event message types, among other information.

Similarly, in some examples, the method can include displaying an indicator particular screen (e.g., accounts, advantage, etc.) of an application such as a mobile application displayed on the GUI of the user device at a time the error event was encountered. The element displayed in the GUI of the user device is located on along with the representations of each of the different error event message types, among other information.

In some examples, a percentage of a total number of inputs to the element displayed in the GUIs of a plurality of user devices over a period of time that resulted in error events. That is, a total number of inputs provided over a period of time (e.g., week, day, hour, etc.) across a plurality of sessions on a plurality of user devices can be recorded such that a percentage of the total number of inputs to an element of the application represented in the GUIs of the plurality of devices that encounter an error event in response to an input to the element can be determined and/or displayed. In this manner, an element of an application with a comparatively high percentage of error events resulting from inputs provided to the element can be readily identified, for example, by sorting a plurality of elements based on respective percentages of inputs provided thereto that resulted in an error event.

Notably, the method 680 can include representing each of the different error event types associated with a respective unique identifier at the same time in the GUI of the support device, in contrast to other approaches that may display an error event of a particular type (crash) but do not associate such error events with a unique identifier of an input (e.g., an input that resulted in occurrence of the errors), let alone, display an error event type of the event types associated with a unique input identifier at the same time in the GUI of a support device.

The method 680 can, in some examples, include displaying at least one of the different error event messages types in the GUI of the support device as it appeared to a user of the user device. Such a display, particularly in combination with different types of error event messages (e.g., an HTTP error event) can enable support personal to view the message (e.g., an error event notification message) text or other information as it was originally displayed to a user via a GUI of the user device and thereby promote enhanced user experience.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing resource.

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 308 in FIG. 3.

The specification examples provide a description of the applications and use of the system and method of the present disclosure. Many examples can be made without departing from the spirit and scope of the system and method of the present disclosure, this specification sets forth some of the many possible example arrangement and implementations. Elements shown in the various examples herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, “a number of” an element and/or feature can refer to one or more of such elements and/or features. In addition, “for example” and similar phrasing is intended to mean, “by way of example and not by way of limitation”.

What is claimed:

1. A system, comprising:
an associate engine to associate each of a plurality of different error event types encountered in response to an input to an element of an application displayed in a graphical user interface (GUI) of a user device with a unique identifier of the input; and
a represent engine to represent an error event type of the different error event types associated with the unique input identifier in a GUI of a support device.

2. The system of claim 1, where the representation of the error event type of the different error event types includes an error event notification message originally displayed by the GUI of the user device.

3. The system of claim 1, where the application is a mobile application and where the user device is a mobile user device.

4. The system of claim 3, including a record engine to record the plurality of different error event types during all sessions of all users using the mobile application on a plurality of mobile user devices.

5. The system of claim 1, where the plurality of different error event types include a first error event type that is a Hypertext Transfer Protocol error event, a crash error event, or a handled exception error event.

6. The system of claim 5, including a second error event type that is an error event notification message displayed in the GUI of the user device in response to occurrence of the first error event type.

7. The system of claim 1, where the user device and the support device are separate and distinct.

8. A non-transitory machine-readable medium including instructions executable by a machine to cause the machine to
record different error event message types displayed in graphical user interfaces (GUI)s of mobile user devices in response to an input to an element of a mobile application displayed in the GUIs, where the inputs are identified by a unique input identifier;
associate each of the different error event message types with the unique input identifier of the input; and
represent each of the different error event message types associated with the unique input identifier in a GUI of a support device.

9. The medium of claim 8, including instructions to represent each of the different error event message types in response to a selection provided via the GUI of the support device to drill down on a representation of the input.

10. The medium of claim 8, including instructions to display a percentage of a total number of inputs to the element displayed in the GUIs of the mobile user devices that resulted in error events.

11. The medium of claim 8, including instructions to associate each of the different error event message types with a single unique input identifier of the input.

12. A method, comprising:
recording different error event message types displayed in a plurality of graphical user interface (GUI)s of a plurality of user devices in response to a input to an element of a mobile application displayed in the GUIs during sessions of the mobile application;
associating each of the recorded different error event message types with an unique identifier of the input; and
representing each of the different error event message types associated with the unique input identifier in a GUI of a support device.

13. The method of claim 12, including representing each of the different error event types at the same time in the GUI of the support device.

14. The method of claim 12, including associating respective thread identifiers of each of the recorded different error event message types with a unique identifier of the input.

15. The method of claim 12, including displaying content of at least one of the different error event message types in the GUI of the support device as it appeared to a user of the user device.
